(19) United States
(12) Patent Application Publication
(10) Pub. No.: US 2009/0087251 A1
(43) Pub. Date: Apr. 2, 2009

(54) TELESCOPIC DEVICE

(76) Inventor: Chao-Ken Chen, Taipei Hsien (TW)

Correspondence Address: Chao-Ken Chen, 235 Chung - Ho, Box 8-24, Taipei, TW

(21) Appl. No.: 12/211,826

(22) Filed: Sep. 17, 2008

(30) Foreign Application Priority Data
Sep. 29, 2007 (TW) 096216266

(51) Int. Cl. F16B 7/10; F16M 11/26

(52) U.S. Cl. 403/109.1; 248/404; 248/407

(57) ABSTRACT

A telescopic device includes an outer tube, an inner tube, a sustaining rod, an elastic body, and a locking device. The outer tube receives the inner tube for axial traveling. A positioning portion is formed opposite to the locking device on the inner tube, the inner tube is free to axially travel inside the outer tube and only stopped by the engagement of the locking device and the positioning portion. The sustaining rod is arranged inside the outer tube, an end thereof is fixed to a retaining seat of the outer tube and another end serves to sustain the elastic body. The elastic body is arranged inside the inner tube, the two ends thereof are fixed to the opposite sides of an end of the inner tube.

### FIELD OF THE PRESENT INVENTION

The present invention relates to an adjustable device, and particular to a telescopic device which is capable of carrying a table plate or exhibition frame so that the position of the carried object can be changed by the axial traveling of the device.

### DESCRIPTION OF THE PRIOR ART

To meet the needs of the users, adjustable devices are designed to change the position of the object in different situations. For example, the adjustable heights of a chair, a table plate, or an exhibition frame can make the best use of the tools in proper positions.

For the purpose of adjusting positions of the height or the length of objects, a common method is to link the objects to an air cylinder. The needs are satisfied but the cost is too high for the makers.

### SUMMARY OF THE PRESENT INVENTION

Accordingly, the primary object of the present invention is to provide a telescopic device. The device is composed of simple mechanisms to carry object such as a chair, a table plate, or an exhibition frame so as to adjust the positions to make the best use of those, and the manufacture cost of the device is substantially lowered.

To achieve above object, the present invention provides a telescopic device includes an outer tube, an inner tube, a sustaining rod, an elastic body and a locking device, wherein the outer tube has a long body, and a first end portion and a second end portion axially extending from two ends of the body respectively; a hollow portion of the body is a hollow space penetrating through the first and second end portions and for receiving the inner tube; the first end portion is connected with a retaining seat, and the second end portion is connected with the lock device; the inner tube has a long body, and a first end portion and a second end portion extending from on the two ends of the body respectively; the body has a hollow portion which is a hollow space and penetrates through the first end portion; the first and second end portions and are free to travel inside the hollow portion of the outer tube; the inner tube has a positioning portion for engaging the locking device; the sustaining rod is arranged in the hollow portion of the outer tube; the sustaining rod has a long body, and a first end portion and a second end portion axially extending from the two ends of the body respectively; the first end portion serves to fix the sustaining rod to the retaining seat and the second end portion serves to sustain the elastic body; the elastic body is arranged in the hollow portion of the inner tube; the elastic body has a long body, and a first end portion and a second end portion axially extending from the two ends of the body respectively; the two ends are fixed to two opposite edges of the first end portion of the inner tube.

### BRIEF DESCRIPTION OF THE DRAWINGS

FIG. 1 is an exploded view of the present invention.

FIG. 2 is a schematic view showing the assembly of the present invention.

FIG. 3 is a prospective view showing an inner tube extends from an outer tube.

FIG. 4 is a schematic view showing the inner tube extends from the outer tube.

FIG. 5 is a prospective view showing the inner tube contracts inside the outer tube.

FIG. 6 is a schematic view showing the inner tube contracts inside the outer tube.

FIG. 7 is a schematic view showing another preferable embodiment of the present invention that two telescopic devices are applied to support a table plate.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

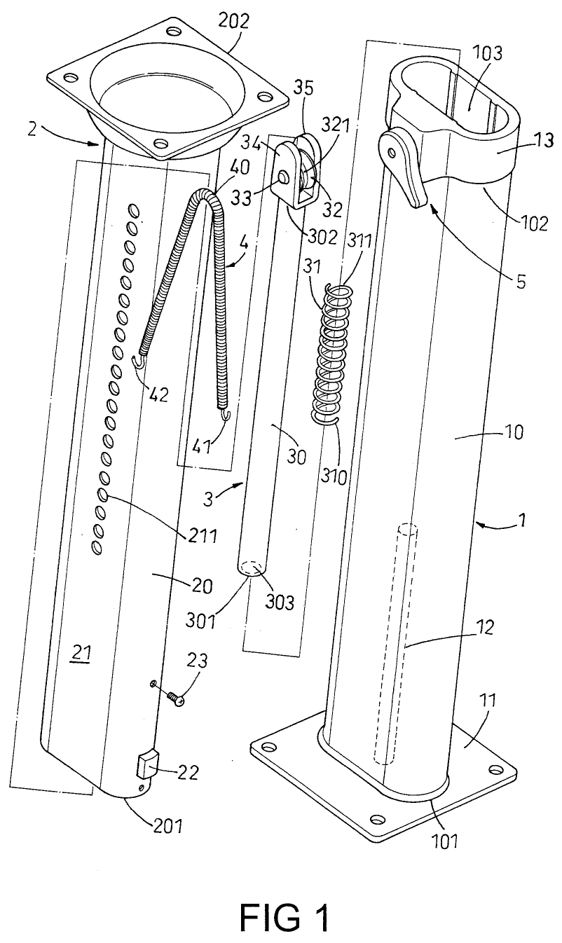

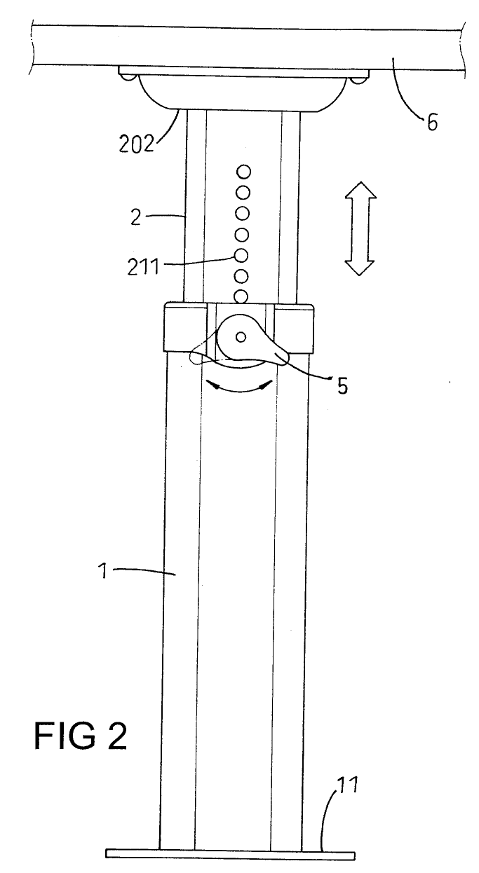

As shown in FIGS. 1 to 3, the present invention includes an outer tube 1, an inner tube 2, a sustaining rod 3, an elastic body 4, and a lock device 5.

The outer tube 1 has a long body 10 and a first end portion 101 and a second end portion 102 on the two ends of the body 10 respectively. A hollow portion 103 is a hollow space penetrates through the body 10 and the first and second end portions 101 and 102 where the inner tube 2 is received for axial traveling. The first end portion 101 connects a retaining seat 11, and the second end portion 102 connects the lock device 5.

The inner tube 2 has a long body 20 and a first end portion 201 and a second end portion 202 on the two ends of the body 20 respectively. A hollow portion 203 is a hollow space penetrates through the body 20 and the first end portion 201 where the sustaining rod 3 and the elastic body 4 are received when the inner tube 2 is inserted into the outer tube 1. The first and second end portions 201 and 202 are free to travel inside the hollow portion 103 of the outer tube 1. The second end portion 202 is capable of carrying an object such as a table plate 6 or an exhibition frame so that the object can be moved by the axial movement of the inner tube 2. The inner tube 2 has a positioning portion 211 which is formed axially with at least one positioning hole opposite to the locking device 5. The inner tube 2 can be locked to the outer tube 1 by the engagement of the locking device 5 and the positioning portion 211.

The sustaining rod 3 is arranged in the hollow portion 103 of the outer tube 1. The sustaining rod 3 has a long body 30 and a first end portion 301 and a second end portion 302 on the two ends of the body 30 respectively. A hollow portion 303 is a hollow space penetrates the first end portion 301 and the body 30. The first end portion 301 serves to fix the sustaining rod 3 to the retaining seat 11 of the outer tube 1 and the second end portion 302 serves to sustain the elastic body 4.

The elastic body 4 is arranged in the hollow portion 203 of the inner tube 2. The elastic body 4 has a long body 40 and a first end portion 41 and a second end portion 42 on the two ends of the body 40 respectively. The two ends 41 and 42 are fixed to two opposite edges of the first end portion 201 of the inner tube 2. The elastic body 4 shown in the Figs. is an extendable spring, the body 40 of the spring is sustained by the second end portion 302 of the sustaining rod 3 so that the elastic body 4 shows a approximately V shape after assembled.

A positioning column 12 is formed on the retaining seat 11 extending towards the hollow portion 103 of the outer tube 1 for fixing the sustaining rod 3. The cross-section area of the positioning column 12 is smaller than that of the hollow portion 303 of the sustaining rod 3 so that the sustaining rod 3 can be slid into the positioning column 12. Preferably, a compressive spring 31 is arranged between the retaining seat 11 and the first end portion 301 of the sustaining rod 3 with ends 310 and 311 of the spring 31.

The second end portion 302 of the sustaining rod 3 has a rolling wheel 32, which the radial surface of the wheel has a round recess 321 for receiving the body 40 of the elastic body 4. The rolling wheel 32 is penetrated by an axle 33, and the two ends of the axle 33 are fixed by opposite wing sheets 34 and 35. Each wing sheet has an end links to each other and connected to the second end portion 302 of the sustaining rod 3. The height of the wing sheets is higher than the rolling wheel to cover the elastic body from escaping.

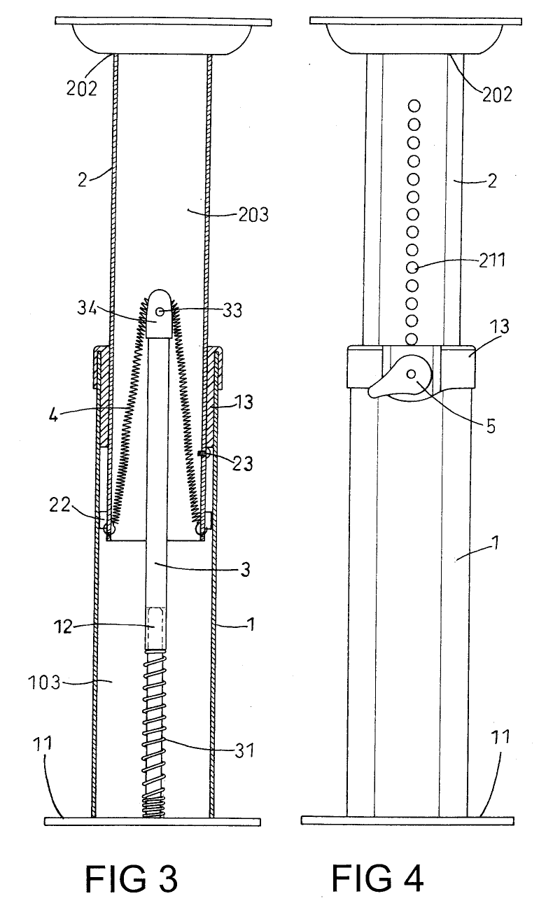

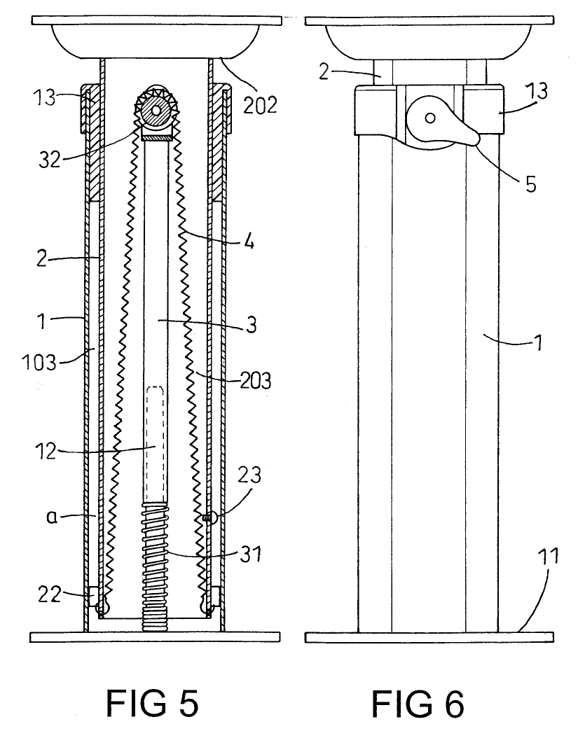

As shown in FIGS. 3 and 4, when assembling, the compressive spring 31 and the sustaining rod 3 are slid into the positioning column 12 of the outer tube 1 by orders so that the end 310 of the spring 31 is pushed against the retaining seat 11 and another end 311 is pushed against the first end portion 301 of the sustaining rod 3. The inner tube 2 installed with the elastic body 4 is slid into the hollow portion 103 through the second end portion 102 of the outer tube 1. The inner tube will be supported while the body 40 of the elastic body 4 is received by the recess 321 of the rolling wheel 32. Meanwhile, the second end portion 202 of the inner tube 2 is at the farthest position from the outer tube 1. When operating, as shown in FIGS. 5 and 6, the second end portion 202 of the inner tube 2 is pushed towards the outer tube 1. By the tension of the elastic body 4, the inner tube 2 will be pushed steady to a predetermined position and will be locked by the engagement of the locking device 5 and the positioning portion 211. Meanwhile, the spring 31 is pushed and deformed. To restore the position of the second end portion 202 of the inner tube 2, the locking device 5 is released from the positioning portion 211 and the bounce of the spring 31 will save the strength for the user.

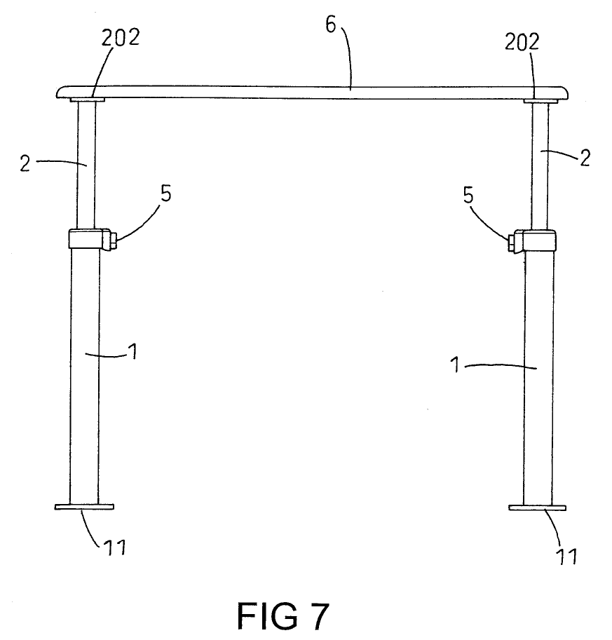

As shown in FIG. 7, the second end portion 202 is capable of carrying an object such as a table plate 6 or an exhibition frame. Through the function of the present invention, the height of the table plate 6 is adjustable. Obviously, to increase the practicability, a plurality of the present inventions can be symmetrically applied to a large object.

Otherwise, with reference to FIG. 1 to 3, a pair of spacer 22 is formed symmetrically on the two sides of the inner tube 2 near the first end portion 201 for meeting the gap a between the inner and outer tube to prevent a sway of the inner tube 2. Furthermore, a ring 13 is arranged to the second end portion 102 of the outer tube 1. A stopper 23 such as a bolt shown in the FIG. 1 is installed to the surface of the inner tube 2 near the first end portion 201. Through the stop of the ring 13 and the stopper 23, the inner tube 2 is prevented from pulling out from the outer tube 1 caused by a wrong operation.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A telescopic device includes an outer tube 1, an inner tube 2, a sustaining rod 3, an elastic body 4 and a locking device 5, wherein
the outer tube 1 has a long body 10, and a first end portion 101 and a second end portion 102 axially extending from two ends of the body respectively; a hollow portion 103 of the body 10 is a hollow space penetrating through the first and second end portions 101 and 102 for receiving the inner tube 2; the first end portion 101 is connected with a retaining seat 11, and the second end portion 102 is connected with the lock device 5;
the inner tube 2 has a long body 20, and a first end portion 201 and a second end portion 202 extending from on the two ends of the body 20 respectively; the body 20 has a hollow portion 203 which is a hollow space and penetrates through the first end portion 201; the first and second end portions 201 and 202 are free to travel inside the hollow portion 203 of the outer tube 1; the inner tube 2 has a positioning portion 211 for engaging the locking device 5;
the sustaining rod 3 is arranged in the hollow portion 103 of the outer tube 1; the sustaining rod 3 has a long body 30, and a first end portion 301 and a second end portion 302 axially extending from the two ends of the body 30 respectively; the first end portion 301 serves to fix the sustaining rod 3 to the retaining seat 11 and the second end portion 302 serves to sustain the elastic body 4;
the elastic body 4 is arranged in the hollow portion 203 of the inner tube 2; the elastic body 4 has a long body 40, and a first end portion 41 and a second end portion 42 axially extending from the two ends of the body 40 respectively; the two ends are fixed to two opposite edges of the first end portion 201 of the inner tube 2.

2. The telescopic device as claimed in claim 1, wherein the body 30 of the sustaining rod 3 has a hollow portion 303 which is a hollow space penetrating through the first end portion 301 and the body 30; a positioning column 12 is formed on the retaining seat 11 extending towards the hollow portion 103 of the outer tube 1; the cross-section area of the positioning column 12 is smaller then that of the hollow portion 303 of the sustaining rod 3 so that the sustaining rod 3 can slide into the positioning column 12 and is positioned.

3. The telescopic device as claimed in claim 2, wherein a compressive spring 31 encloses the positioning column 12; an end of the spring 31 resists against the retaining seat 11 and another end thereof resists against the first end portion 301 of the sustaining rod 3.

4. The telescopic device as claimed in claim 1, wherein the second end portion 302 of the sustaining rod 3 has a rolling wheel 32, a radial surface of the wheel has a round recess 321 for receiving the body 40 of the elastic body 4.

5. The telescopic device as claimed in claim 4, wherein the rolling wheel 32 is penetrated by an axle 33, and the two ends of the axle 33 are fixed by opposite wing sheets 34 and 35; each wing sheet has an end linking to each other and connected to the second end portion 302 of the sustaining rod 3; heights of the wing sheets 34 and 35 are higher than that the rolling wheel 32 for protecting the elastic body 4 from escaping.

6. The telescopic device as claimed in claim 1, wherein the elastic body 4 is an expendable spring.

7. The telescopic device as claimed in claim 1, wherein the positioning portion 211 of the inner tube 2 is formed axially with at least one hole.

8. The telescopic device as claimed in claim 1, wherein a pair of spacer 22 is formed symmetrically on the two sides of the body 20 of the inner tube 2 for filling a gap a between the inner tube 2 and an inner wall of the outer tube 1.

9. The telescopic device as claimed in claim 1, wherein a ring 13 is arranged to the second end portion 102 of the outer tube 1; a stopper 23 is installed to a surface of the inner tube 2 near the first end portion 201; through the stop of the ring 13 and the stopper 23, the inner tube 2 is prevented from pulling out from the outer tube 1.

10. The telescopic device as claimed in claim 1, wherein the second end portion 202 of the inner tube 2 is capable of carrying an object; the position of the carried object is adjustable by the axial traveling of the inner tube 2.

11. The telescopic device as claimed in claim 10, wherein the object is selected from a table plate 6 and an exhibition frame.
